(19) United States
(12) Patent Application Publication
(10) Pub. No.: US 2023/0280957 A1
(43) Pub. Date: Sep. 7, 2023

(54) PRINT JOB MANAGEMENT DEVICE, PRINT JOB MANAGEMENT METHOD, AND NON-TRANSITORY COMPUTER-READABLE STORAGE MEDIUM STORING PRINT JOB MANAGEMENT PROGRAM

(71) Applicant: SEIKO EPSON CORPORATION, Tokyo (JP)

(72) Inventor: Ryo FUJIOKA, MATSUMOTO-SHI (JP)

(21) Appl. No.: 18/177,599

(22) Filed: Mar. 2, 2023

(30) Foreign Application Priority Data
Mar. 3, 2022 (JP) 2022-032534

(51) Int. Cl. G06F 3/12

(52) U.S. Cl. CPC G06F 3/1261; G06F 3/1208

(57) ABSTRACT

A print job management device includes: a management unit causing a printing device to execute a print job; a holding unit causing a storage medium to hold color information associated with a color gamut of a printing device that is an execution agent of the print job that is interrupted, when the print job is interrupted; and a selection unit selecting, as a candidate, a printing device that can print a color used in the print job that is interrupted, based on the color information.

The present application is based on, and claims priority from JP Application Serial Number 2022-032534, filed Mar. 3, 2022, the disclosure of which is hereby incorporated by reference herein in its entirety.

### BACKGROUND

### 1. Technical Field

The present disclosure relates to a print job management device, a print job management method, and a non-transitory computer-readable storage medium storing a print job management program.

### 2. Related Art

According to the related art, a system in which, even in a state where one image forming device of a plurality of image forming devices is unable to output, an unprocessed job of divided jobs is outputted normally and continuously, using another image forming device, is known. JP-A-2002-268850 is an example of the related art.

The color that can be outputted by a printing device can vary from one printing device to another. In the related art, there are cases where a color cannot be outputted as expected in an interrupted print job.

### SUMMARY

According to an aspect of the present disclosure, a print job management device includes: a management unit causing a printing device to execute a print job; a holding unit causing a storage medium to hold color information associated with a color gamut of a printing device that is an execution agent of the print job that is interrupted, when the print job is interrupted; and a selection unit selecting, as a candidate, a printing device that can print a color used in the print job that is interrupted, based on the color information.

According to another aspect of the present disclosure, a print job management method includes: a management step of causing a printing device to execute a print job; a holding step of causing a storage medium to hold color information associated with a color gamut of a printing device that is an execution agent of the print job that is interrupted, when the print job is interrupted; and a selection step of selecting, as a candidate, a printing device that can print a color used in the print job that is interrupted, based on the color information.

According to still another aspect of the present disclosure, a non-transitory computer-readable storage medium storing a print job management program is provided. The program causes a computer to function as: a management unit causing a printing device to execute a print job; a holding unit causing a storage medium to hold color information associated with a color gamut of a printing device that is an execution agent of the print job that is interrupted, when the print job is interrupted; and a selection unit selecting, as a candidate, a printing device that can print a color used in the print job that is interrupted, based on the color information.

### BRIEF DESCRIPTION OF THE DRAWINGS

FIG. 1 schematically shows an example of a print job management system.

FIG. 2 is a block diagram showing the configuration of a print job management device.

FIG. 3 is a block diagram showing an example of case data.

FIG. 4 is a block diagram showing an example of process management data.

FIG. 5 is a block diagram showing the configuration of a manager terminal.

FIG. 6 is a block diagram showing the configuration of an information processing device.

FIG. 7 is a block diagram showing the configuration of a printing device.

FIG. 8 is a flowchart of processing including an interruption of a print job.

FIG. 9 is a flowchart of processing including a resumption of the print job.

FIG. 10 is a flowchart of processing of acquiring a candidate of the printing device.

### DESCRIPTION OF EXEMPLARY EMBODIMENTS

An embodiment of the present disclosure will now be described in the following order.
(1) System Configuration
(1-1) Configuration of Print Job Management Device
(1-2) Configuration of Manager Terminal
(1-3) Configuration of Information Processing Device
(1-4) Configuration of Printing Device
(2) Management of Interrupted Print Job
(2-1) Resumption of Print Job
(2-2) Acquisition of Candidate of Printing Device
(3) Other Embodiments

### (1) System Configuration

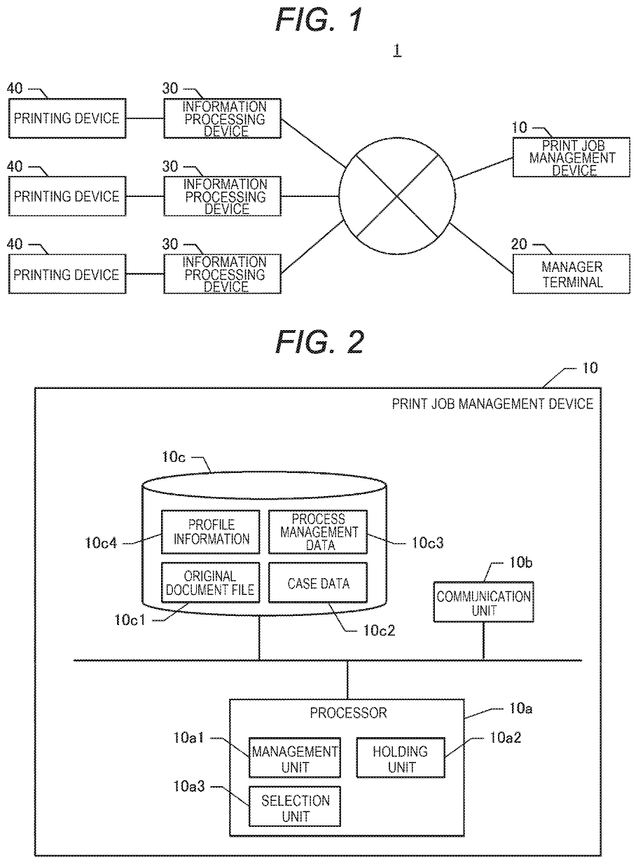

FIG. 1 schematically shows an example of a print job management system according to an embodiment of the present disclosure. A print job management system 1 includes a print job management device 10, a manager terminal 20, an information processing device 30, and a printing device 40. In this embodiment, the printing device 40 is coupled to the information processing device 30. A manager can access information held in the print job management device 10, using the manager terminal 20. In this embodiment, the number of the devices illustrated in FIG. 1 is an example and is not limited. For example, the information processing devices 30 and the printing devices 40 described as a plurality of devices are not limited to the number illustrated in FIG. 1, and the print job management device 10 and the manager terminal 20 or the like described as a single device may be provided in a plurality. In this embodiment, the execution agent of a print job is the printing device 40.

In this embodiment, the print job management device 10, the manager terminal 20, and the information processing device 30 can communicate with each other via a network. Various forms of networks may be employed. A local area network may be used. Also, the devices located at physically distant places may communicate with each other via the internet or the like. Also, the printing device 40 may be able to communicate with the print job management device 10 and the manager terminal 20. In this embodiment, the print job management system 1 is a system for printing a printed object. However, another process, for example, surface processing or the like, may be performed on the printed object after the printing.

In this embodiment, a manager receiving a request to produce a printed object from a client prints printed objects according to a plurality of requests, using a plurality of printing devices 40. In this embodiment, a set of requests for products that are requested by the same client and can be delivered in a batch is referred to as a case. The manager operates the manager terminal 20 and thus inputs information representing the content of the requested case. The manager terminal 20 transmits this information to the print job management device 10. The print job management device 10 generates a print job for printing corresponding to the requested case and instructs the information processing device 30 to execute the print job. The information processing device 30 performs processing to execute the print job, thus generates print data, and causes the printing device 40 to execute printing based on the print data.

In this embodiment, it is assumed that a plurality of requests are accepted from a plurality of clients. In this embodiment, in order to allow the plurality of printing devices 40 to smoothly execute print jobs according to a plurality of requests in parallel, the print job management device 10 decides a printing device to execute a print job and an order of execution of a print job by each printing device. The print job management device 10 causes the decided printing device to execute the print job in the decided order of execution and thus manages the progress of the print job.

In the process of executing the print jobs in this way, there are cases where a print job is interrupted due to a circumstance that is not expected at the time of deciding the order of execution of the print jobs. To meet the request from the client even when a print job is interrupted, the interrupted print job needs to be resumed. In this embodiment, the plurality of printing devices 40 operate and the states of the printing devices 40 may differ from the states at the time of interruption, due to the replacement or the like of a coloring material or a print medium in each printing device 40 with the progress of printing. Also, not all of the plurality of printing devices 40 can necessarily execute printing using the color expected in the interrupted print job. Therefore, this embodiment is configured in such a way that the manager can select a printing device 40 that can execute printing using color information associated with the color gamut of the interrupted print job.

The configuration of each device in the print job management system 1 that enables such selection will now be described.

### (1-1) Configuration of Print Job Management Device

FIG. 2 is a block diagram showing the configuration of the print job management device 10. The print job management device 10 has a processor 10a, a communication unit 10b, and a storage medium 10c. The processor 10a has a CPU, a ROM, a RAM or the like, not illustrated, and executes various programs recorded in the storage medium 10c and thus can control each unit in the print job management device 10 and each device coupled to the network. The processor 10a may be formed of a single chip or a plurality of chips, or may be formed as an SoC with various functional blocks that cause the printing device to operate. Also, for example, an ASIC may be employed instead of the CPU. Alternatively, a configuration where a CPU and an ASIC cooperate with each other may be employed. When each device in this embodiment has a processor, the processor can be implemented in various forms similarly to the processor 10a.

The communication unit 10b includes a communication interface for communicating with an external device in conformity with various wired or wireless communication protocols. The print job management device 10 can communicate with another device via the communication unit 10b. The communication unit 10b may include an interface for communicating with various removable memories attached to the print job management device 10.

In the storage medium 10c of the print job management device 10, various information is stored. For example, the storage medium 10c includes an original document file 10c1 representing a print target such as a character or an image. The original document file 10c1 is a file including data representing a content to be printed on a printed object. For example, a pdf file or the like can be the original document file 10c1.

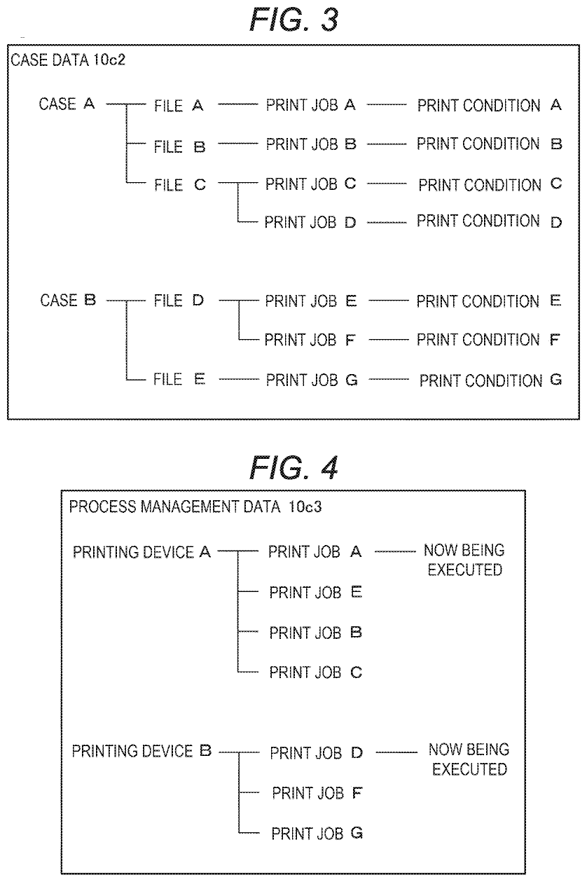

The storage medium 10c also includes case data 10c2 representing a requested case. The case data 10c2 includes, for each case, necessary information for printing each case. FIG. 3 schematically shows a form of the case data 10c2. In this embodiment, the case data 10c2 includes the identification information of each case, the identification information (file name or the like) of the original document file 10c1 representing the print content of each case, the identification information of a print job executed based on each original document file 10c1, and a print condition of each print job.

In FIG. 3, the identification information of the case is illustrated as case A, B or the like. The identification information of the original document file 10c1 is illustrated as file A, B or the like. The identification information of the print job is illustrated as print job A, B or the like. The print condition is illustrated as print condition A, B or the like.

In this embodiment, there are cases where one case is formed of printing using a plurality of original document files 10c1. In FIG. 3, a line extending from the identification information of the case to the identification information of the file indicates the original document file 10c1 forming the case. For example, the case A is formed of the files A, B, and C, and the case B is formed of the files D and E.

A print job is a series of processes to acquire a printed object based on the original document file 10c1 representing a print target. In this embodiment, when the information processing device 30 is instructed to print a specific original document file 10c1 with a specific print condition, the information processing device 30 performs processing based on the original document file 10c1 and causes the printing device 40 to execute printing. Thus, in this embodiment, a print job is generated by establishing a correspondence between an original document file 10c1 and a print condition. In FIG. 3, a line extending from the identification information of the original document file 10c1 to the identification information of the print job establishes a correspondence with the print job to be executed based on each original document file 10c1. In this embodiment, the same original document file 10c1 may be divided into a plurality of print jobs. For example, the printed object based on the file C in FIG. 3 is printed by a job divided into the print jobs C and D.

A correspondence between each print job and the print condition corresponding to each print job is established for each print job. The print condition is information representing the content of an item that can be set when the printing device executes printing. The form of the print condition is not limited. However, for example, the print condition is defined by establishing a correspondence with information representing the content of each item such as the number of products delivered (number of print copies), the type of the coloring material, the type of the print medium, the size of the print medium, the color used (color, black and white, or the like), or the color of a specific object (spot color or sample color). Spot color information representing a spot color or sample color information representing a sample color may be defined in various forms. In this embodiment, a spot color or a sample color is designated by coordinate values in the CIELAB space, which is a device-independent color space. Of course, for a print job where a spot color or a sample color is not designated, the print condition may not include the spot color information or the sample color information.

In this embodiment, a color profile used by the printing device corresponds to a combination of a coloring material and a print medium. If the combination of the coloring material and the print medium is decided, the color profile to be used is decided. The print condition includes the type of the coloring material and the type of the print medium. Therefore, it can be said that the print condition practically includes information for specifying the color profile to be used in the print job. Of course, the print condition may include information directly representing the color profile to be used, for example, the identification information thereof, or the like.

The information representing the type of the coloring material, the type of the print medium, the spot color, the sample color, and the color profile is color information associated with the color gamut of the printing device that is the execution agent of the print job. That is, if the type of the coloring material used in the printing device changes, the color gamut, which is a range of colors that can be outputted, can change. Therefore, the type of the coloring material is the color information associated with the color gamut. Also, if the type of the print medium used in the printing device changes, the color gamut, which is a range of colors that can be outputted, can change. Therefore, the type of the print medium is the color information associated with the color gamut.

When the print condition includes the spot color information representing a spot color, this spot color should be able to be outputted in the print job executed with this print condition and the printing device that is the execution agent of the print job should have at least a color gamut including this spot color. Therefore, the spot color information is the color information associated with the color gamut. When the print condition includes the sample color information representing a sample color, this sample color should be able to be outputted in the print job executed with this print condition and the printing device that is the execution agent of the print job should have at least a color gamut including this sample color. Therefore, the sample color information is the color information associated with the color gamut. The color profile is information establishing a correspondence between a gradation value indicating the amount of the coloring material used per color, of the coloring material usable in the printing device 40, and coordinates in a device-independent color space. Thus, the color profile represents a range of colors that can be outputted by the printing device that is the execution agent of the print job. Therefore, the information representing the color profile is the color information associated with the color gamut.

The case data 10c2 may also include information inputted by the manager about each case, for example, the identification information (name) of the case, the date of delivery, the worker involved in the process, or the like. The original document file 10c1 and the case data 10c2 as described above are saved in the storage medium 10c by the manager inputting these file and data via the manager terminal 20.

The storage medium 10c also includes process management data 10c3, which is necessary information for the process management of the print job. In this embodiment, the process management data 10c3 includes information representing a print job to be executed by the printing device 40 and an order of processing each print job. FIG. 4 schematically shows a form of the process management data 10c3. In this embodiment, the process management data 10c3 includes the identification information of each printing device, the identification information of a print job allocated to each printing device, and the order of execution of each print job.

In FIG. 4, the identification information of the printing device is described as printing device A, B or the like, and a print job is made to correspond to each printing device. In FIG. 4, a print job that is earlier in the order of execution is shown at an upper position. For example, print jobs for which the printing device A is the execution agent are executed in the order of the print jobs A, E, B, and C. In this embodiment, the process management data 10c3 is generated by the print job management device 10. That is, the print job management device 10 specifies a printing device that is the execution agent of print jobs, based on the case data 10c2, decides the order of execution of the print jobs, and generates the process management data 10c3.

In this embodiment, to each print job, the status of the print job is made correspond. In the example shown in FIG. 4, the print jobs A and D are now being executed and the other print jobs are waiting for execution. In this embodiment, the print job management device 10 receives information that the print job is started or completed or the like, from the information processing device 30, and changes the status, based on such information. Other statuses than “now being executed” and “waiting for execution” may be provided. For example, a status of “waiting for print condition setting” or the like may be provided.

In this embodiment, the state where a print queue based on the original document file 10c1 exists is the state where a print job exists. That is, a print job is registered in the process management data 10c3 and thus enters into an execution waiting state. On completion of the printing, the processor 10a deletes the completed print job from the process management data 10c3. Therefore, the print job exists during the period until the printing is completed after the print job is registered in the execution waiting list in the printing device.

In this embodiment, the manager can interrupt a print job by operating the manager terminal 20 as described later. The interruption of a print job occurs when processing related to printing or a print operation is stopped during the period until the printing based on the print job is completed after the print job is registered in the process management data 10c3. Various causes of the interruption of a print job are conceivable. The interruption can occur in response to an instruction from the manager. Also, the interruption can occur due to an error such as a print medium jam or running out of a consumable part in the printing device.

Also, profile information 10c4 is recorded in the storage medium 10c. The profile information 10c4 is information for color conversion in the printing device 40 and is information establishing a correspondence between a gradation value indicating the amount of the coloring material used per color, of the coloring material usable in the printing device 40, and coordinates in a device-independent color space. The profile information 10c4 may employ various formats. For example, a color conversion table prescribing a correspondence relationship between a gradation value per color of the coloring material and coordinate values in the CIELAB space, which is a device-independent color space, for a plurality of sets, or a function representing this correspondence relationship, or the like, can form the profile information 10c4.

The profile information 10c4 is defined for each model of the printing device 40 and for each type of the coloring material and the print medium used in the printing device 40 and is held in the storage medium 10c. That is, in this embodiment, the plurality of printing devices 40 can execute printing based on a print job, and in the print job management device 10, the profile information 10c4 is recorded, corresponding to the identification information of each printing device 40 that can execute the printing and a combination of a coloring material and a recording medium.

### (1-2) Configuration of Manager Terminal

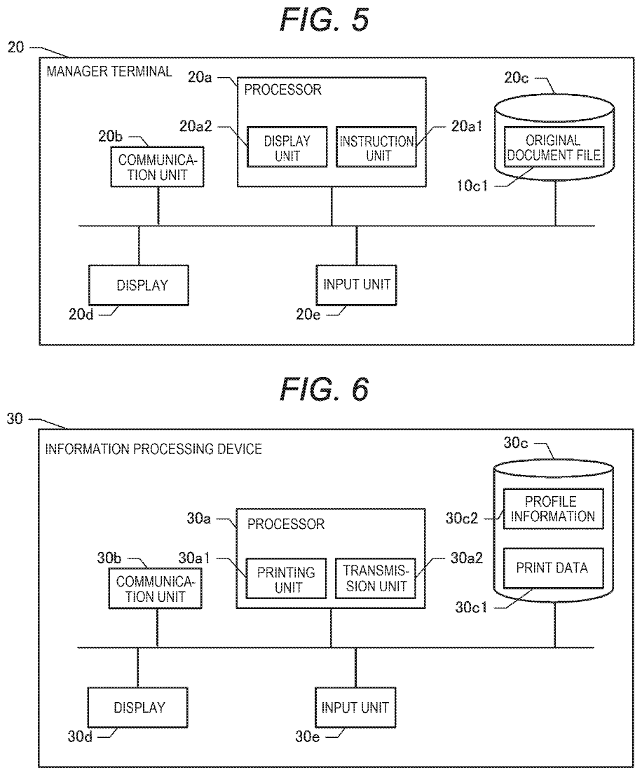

FIG. 5 is a block diagram showing the configuration of the manager terminal 20. The manager terminal 20 has a processor 20a, a communication unit 20b, a storage medium 20c, a display 20d, and an input unit 20e. The processor 20a has a CPU, a ROM, a RAM or the like, not illustrated, and executes various programs recorded in the storage medium 20c and thus can control each unit in the manager terminal 20.

The communication unit 20b includes a communication interface for communicating with an external device in conformity with various wired or wireless communication protocols. The manager terminal 20 can communicate with another device via the communication unit 20b. The communication unit 20b may include an interface for communicating with various removable memories attached to the manager terminal 20.

In the storage medium 20c of the manager terminal 20, the original document file 10c1 representing a print target in a case requested by a client is recorded. The original document file 10c1 may be recorded in any form in the storage medium 20c. For example, the original document file 10c1 prepared by the client requesting the printing may be recorded in a removable memory and may be transferred from the removable memory to the storage medium 20c via the communication unit 20b. Also, the original document file 10c1 may be acquired from an external device via a network. Also, the manager or the like may create the original document file 10c1 via an application program or the like, using the manager terminal 20, and may record the original document file 10c1 in the storage medium 20c. Of course, the manager or the like may edit an original document created by the client and may record the edited document as the original document file 10c1 in the storage medium 20c. When the original document file 10c1 is inputted, the original document file 10c1 is transferred to the print job management device 10.

The display 20d is a display device displaying an arbitrary image. The input unit 20e is a device with which the manager performs an input operation. For example, the input unit 20e is formed of a keyboard, a mouse, a touch panel or the like. In any case, the manager can operate the input unit 20e to input an intention of the manager while visually recognizing an image or a character displayed on the display 20d. In this embodiment, the manager can input a print condition of a print job, using the display 20d and the input unit 20e of the manager terminal 20 as a user interface. The manager can also cause the display 20d to display a print job allocated to each printing device 40 and information representing the progress of each print job. The manager can also operate the input unit 20e to give an instruction to interrupt a print job. The manager can also visually recognize candidates of the printing device displayed on the display 20d, operate the input unit 20e to select a candidate, and resume the interrupted print job.

### (1-3) Configuration of Information Processing Device

FIG. 6 is a block diagram showing the configuration of the information processing device 30. The information processing device 30 is a device that generates print data for printing by the printing device 40 and controls the printing. In this embodiment, an example where one printing device 40 is coupled to one information processing device 30 is described. However, a plurality of printing devices 40 may be coupled to one information processing device 30.

The information processing device 30 has a processor 30a, a communication unit 30b, a storage medium 30c, a display 30d, and an input unit 30e. The processor 30a has a CPU, a ROM, a RAM or the like, not illustrated, and executes various programs recorded in the storage medium 30c and thus can control each unit in the information processing device 30.

The communication unit 30b includes a communication interface for communicating with an external device in conformity with various wired or wireless communication protocols. The information processing device 30 can communicate with another device via the communication unit 30b. The communication unit 30b may include an interface for communicating with various removable memories attached to the information processing device 30.

In the storage medium 30c of the information processing device 30, print data 30c1 for printing a print target according to a print job and profile information 30c2 are recorded. The print data 30c1 is data generated by the processor 30a executing image processing or the like corresponding to a print condition, based on the original document file 10c1. The print data 30c1 includes data representing the amount of the coloring material used for each pixel, or the like. As the print data 30c1 is handed over to the printing device 40, the printing device 40 executes printing.

The profile information 30c2 is information establishing a correspondence between a gradation value indicating the amount of the coloring material used per color, of the coloring material usable in the printing device 40, and coordinates in a device-independent color space, as described above. The color that can be outputted by the printing device 40 depends on the model of the printing device 40 and the type of the coloring material and the print medium used in the printing device 40. Therefore, in the storage medium 30c of the information processing device 30, the profile information 30c2 for the model of the printing device 40 coupled to this information processing device 30 is held. Also, the profile information 30c2 for each combination of a coloring material and a print medium that can be used in this model is held. The profile information 10c4 saved in the storage medium 10c of the print job management device 10 is profile information for each of the printing devices 40 that can execute the print job. Meanwhile, the profile information 30c2 saved in the information processing device 30 is profile information of the printing device 40 coupled to the information processing device 30.

The display 30d is a display device displaying an arbitrary image. The input unit 30e is a device with which a user such as the manager performs an input operation. For example, the input unit 30e is formed of a keyboard, a mouse, a touch panel or the like. Various information may be displayed on the display 30d, and the input unit 30e is configured in such a way that the user can operate the input unit 30e to execute various inputs. In this embodiment, the management of a print job, the display of the progress of a process, the instruction to interrupt a print job, and the like, are performed at the manager terminal 20 but may be able to be performed by the information processing device 30.

In this embodiment, a plurality of printing devices 40 are installed in a facility owned by a printing company and print jobs in cases based on a plurality of requests from a plurality of clients can be executed in parallel. The print job management device 10 generates the process management data 10c3 in which the order of execution of the print jobs corresponds to each of the plurality of printing devices 40, and gives an instruction to start printing according to the order of execution represented by this process management data 10c3. In this embodiment, at the start of printing based on a certain print job, the print job management device 10 gives an instruction to start printing to the information processing device 30. That is, the print job management device 10 transmits the original document file 10c1 along with the instruction to start printing, to the information processing device 30 coupled to the printing device 40 that executes the print job.

When the instruction to start printing is given, the processor 30a performs various image processing based on the original document file 10c1 of the print target and generates the print data 30c1. The processor 30a hands over the print data 30c1 to the printing device 40 and causes the printing device 40 to execute printing. When the printing is finished, the processor 30a outputs information representing that the print job is completed, to the print job management device 10 via the communication unit 30b. When the print job management device 10 acquires this information via the communication unit 10b, the processor 10a deletes this print job from the case data 10c2 and the process management data 10c3. The processor 10a also specifies a print job that comes next in the order of execution, based on the process management data 10c3, and gives a print start instruction for this print job.

### (1-4) Configuration of Printing Device

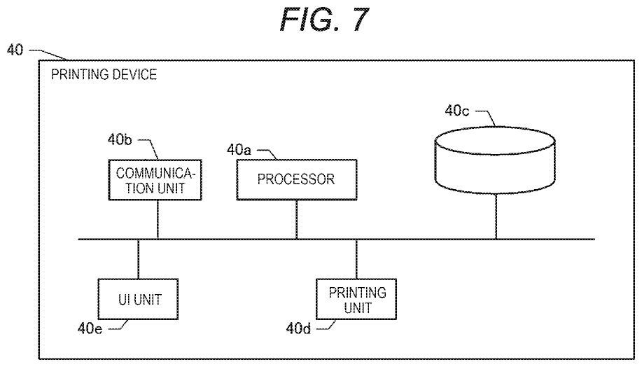

FIG. 7 is a block diagram showing the configuration of the printing device 40. The printing device 40 has a processor 40a, a communication unit 40b, a storage medium 40c, a printing unit 40d, and a UI unit 40e. The processor 40a has a CPU, a ROM, a RAM or the like, not illustrated, and executes various programs recorded in the storage medium 40c and thus can control each unit in the printing device 40.

The communication unit 40b includes a communication interface for communicating with an external device in conformity with various wired or wireless communication protocols. The printing device 40 can communicate with another device via the communication unit 40b. The communication unit 40b may include an interface for communicating with various removable memories attached to the printing device 40.

The printing unit 40d is a part executing printing and may employ various printing methods such as an inkjet method or an electrophotographic method. The printing unit 40d has an actuator, various devices, a sensor, a drive circuit, a mechanical component, and the like, for executing printing on various print media. The sensor includes a sensor detecting various detection targets that can change in the printing device 40. The detection target is not limited. For example, a sensor detecting the amount of remaining print media, a sensor detecting the amount of remaining ink per color used for printing, or the like, may be employed.

The UI unit 40e includes a touch panel display or various keys and switches or the like. The touch panel display has a display panel displaying various information, for example, the status of the printing device 40 and the amount of remaining ink or the like, and a touch detection panel superimposed on the display panel, and thus detects a touch operation made by a human finger or the like. The processor 40a can acquire the content of an operation made by the user such as the manager via the UI unit 40e. The processor 40a can also display various information on the display of the UI unit 40e and thus can notify the user. The user may be able to give an instruction to interrupt a print job via the UI unit 40e.

The processor 40a executes printing in response to an instruction from the information processing device 30. That is, the print data 30c1 is handed over from the information processing device 30 to the printing device 40 when executing printing based on a print job. The processor 40a receives this print data 30c1 via the communication unit 40b, controls the printing unit 40d, and thus executes the printing of the print content represented by the print data 30c1.

### (2) Management of Interrupted Print Job

In the print job management system 1 as described above, the print job management device 10, the manager terminal 20, the information processing device 30, and the printing device 40 cooperate with each other and thus execute a print job. The management of a print job, particularly the management of an interrupted print job, will now be described.

The processor 10a of the print job management device 10 executes a program, not illustrated, and thus functions as a management unit 10a1, a holding unit 10a2, and a selection unit 10a3. The management unit 10a1 is a function of causing the printing device to execute a print job. The holding unit 10a2 is a function of causing the storage medium to hold color information associated with the color gamut of the printing device that is the execution agent of an interrupted print job, when the print job is interrupted. The selection unit 10a3 is a function of selecting, as a candidate, a printing device that can print the color used in the interrupted print job, based on the color information.

The processor 20a of the manager terminal 20 executes a program, not illustrated, and thus functions as an instruction unit 20a1 and a display unit 20a2. The instruction unit 20a1 is a function of accepting various instructions inputted by the manager and giving an instruction to another device. The display unit 20a2 is a function of causing the display 20d to display various information. The processor 30a of the information processing device 30 executes a program, not illustrated, and thus functions as a printing unit 30a1 and a transmission unit 30a2. The printing unit 30a1 is a function of generating the print data 30c1 based on the original document file 10c1 and causing the printing device 40 to execute printing. The transmission unit 30a2 is a function of transmitting the identification information of an interrupted print job to the print job management device 10 when the print job is interrupted.

In the print job management system 1, the manager registers a case requested by a client. That is, the manager operates the input unit 20e and thus designates the original document file 10c1 and inputs the content of the request. The processor 20a transmits information representing the inputted content and the original document file 10c1 by the function of the instruction unit 20a1.

The processor 10a, by the function of the management unit 10a1, acquires the information representing the inputted content and the original document file 10c1 and holds this information and the original document file 10c1 in the storage medium 10c. The information representing the inputted content is added to the case date 10c2. The processor 10a, by the function of the management unit 10a1, specifies the printing device 40 that can execute the print job, based on the print condition or the like, referring to the case data 10c2. The processor 10a, by the function of the management unit 10a1, also allocates the print job to the printing device 40 that can execute the print job, referring to the case data 10c2, then specifies the order of execution of the print job, based on the date of delivery or the like, and thus creates the process management data 10c3.

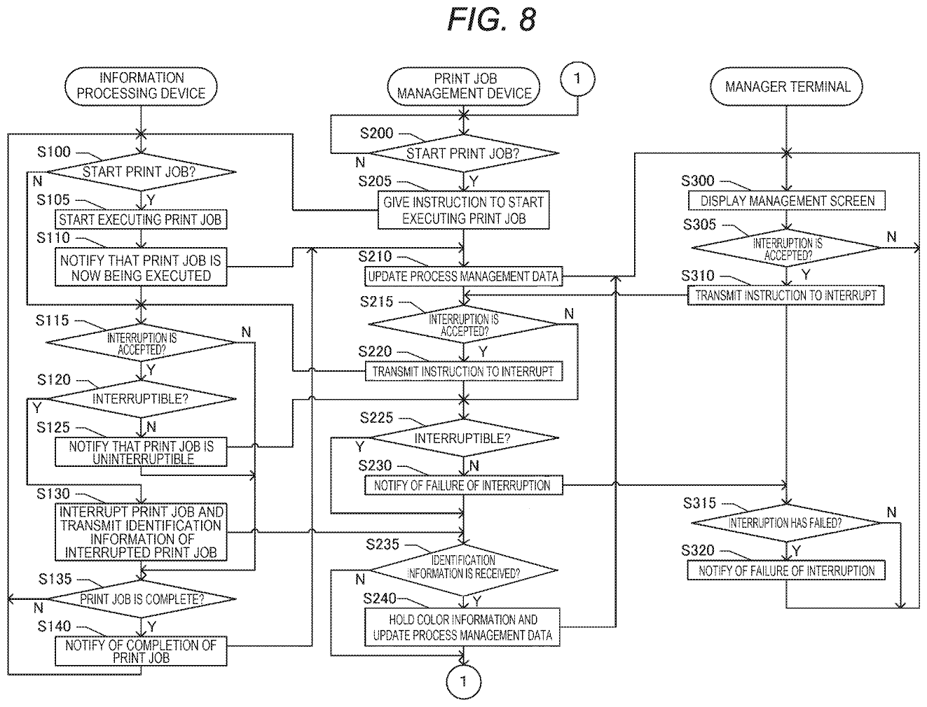

In the state where the process management data 10c3 is created, the execution of the print job is managed. FIG. 8 is a flowchart showing processing in which the print job management device 10, the manager terminal 20, and the information processing device 30 cooperate with each other to manage the execution of a print job. As the process management data 10c3 is created, the processors of the print job management device 10, the manager terminal 20, and the information processing device 30 execute the processing shown in FIG. 8. In FIG. 8, one flowchart for the information processing device is shown. However, a plurality of information processing devices 30 exist. When the processing timings in the plurality of information processing devices 30 coincide with each other, the processing is executed in parallel by the plurality of information processing devices 30.

In this processing, the processor 10a of the print job management device 10, by the function of the management unit 10a1, determines whether a print job should be started or not, based on the process management data 10c3 (step S200). That is, when there is a print job that is at the highest rank in the order of execution represented by the process management data 10c3 and for which an instruction to start executing the print job has not been transmitted to the information processing device 30, the processor 10a determines that the print job should be started.

When it is not determined in step S200 that the print job should be started, the processor 10a repeats the determination of step S200 every predetermined period. Meanwhile, when it is determined in step S200 that the print job should be started, the processor 10a, by the function of the management unit 10a1, gives an instruction to start executing the print job (step S205). That is, the processor 10a transmits an execution start instruction, the print condition, and the original document file 10c1 via the communication unit 10b to the information processing device 30 coupled to the printing device 40 with the print job of the execution target allocated, as the destination of transmission.

In the information processing device 30, the processor 30a, by the function of the printing unit 30a1, determines whether an instruction to start the print job is received or not (step S100). In the information processing device 30 that is the destination of transmission of the execution start instruction, the processor 30a determines that an instruction to start the print job is received. The processor 30a of the information processing device 30 that is not the destination of execution of the execution start instruction does not determine that an instruction to start the print job is received. When it is not determined in step S100 that an instruction to start the print job is received, the processor 30a skips the subsequent steps S105 and S110.

Meanwhile, when it is determined in step S100 that an instruction to start the print job is received, the processor 30a, by the function of the printing unit 30a1, starts executing the print job (step S105). That is, the processor 30a executes image processing or the like to which the print condition of the print job is applied, on the original document file 10c1 transmitted from the print job management device 10, and thus generates the print data 30c1. The processor 30a then hands over the print data 30c1 to the printing device 40 and causes the printing device 40 to execute printing.

In this case, the processor 30a, by the function of the transmission unit 30a2, notifies that the print job is now being executed (step S110). That is, the processor 30a transmits the identification information of the print job that is now being executed, and information that the print job is now being executed, to the print job management device 10 via the communication unit 30b. The processor 10a of the print job management device 10, by the function of the management unit 10a1, receives the information that the print job is now being executed, via the communication unit 10b, and updates the process management data 10c3 (step S210). That is, the processor 10a updates the process management data 10c3 in such a way that the status of the print job that is now being executed turns into “now being executed”.

When the display of a management screen for the print job is executed at the manager terminal 20, the processor 10a, by the function of the management unit 10a1, transmits information that the print job is now being executed, to the manager terminal 20 via the communication unit 10b. That is, the manager terminal 20 can display information such as a list of print jobs and a print job waiting for printing by each printing device.

Specifically, as the manager operates the input unit 20e to give an instruction to display the management screen displaying this information, the processor 20a, by the function of the display unit 20a2, displays the management screen (step S300). That is, the processor 20a outputs an instruction to transmit the process management data 10c3, via the communication unit 20b, and acquires the process management data 10c3 from the print job management device 10. The processor 20a then controls the display 20d to show a display representing the process management data 10c3. Thus, the manager can grasp the print job allocated to the printing device 40 and the order of execution of the print job by the printing device 40. The display target on the management screen is not limited to the information represented by the process management data 10c3 and may be information represented by the case data 10c2 or the like or may be selectable by the manager.

By the above processing, print jobs are executed according to the order of execution. However, a print job can be interrupted for various reasons such as a modification of the content of the request. In this embodiment, the manager can operate the manager terminal 20 to make an interruption. Therefore, the processor 20a, by the function of the instruction unit 20a1, determines whether an interruption is accepted or not (step S305). That is, the processor 20a determines whether the manager has given an instruction to interrupt a designated print job by operating the input unit 20e or not. The instruction to interrupt the print job may be given in various forms. For example, a configuration where a tap on a print job on the management screen or selecting a print job by a mouse pointer or the like on the management screen causes an icon to appear for inputting whether to interrupt or not, can be employed.

When it is not determined in step S305 that an interruption is accepted, the processor 20a repeats the processing from step S300 onward. Meanwhile, when it is determined in step S305 that an interruption is accepted, the processor 20a, by the function of the instruction unit 20a1, transmits an instruction to interrupt the print job to the print job management device 10 via the communication unit 20b (step S310). The instruction to interrupt the print job includes the identification information of the interrupted print job.

In the print job management device 10, the processor 10a determines whether an interruption is accepted or not (step S215). That is, the processor 10a determines whether an instruction to interrupt the print job is received via the communication unit 10b or not. When it is determined in step step 215 that an instruction to interrupt the print job is accepted, the the processor 10a, by the function of the management unit 10a1, transmits an instruction to interrupt the print job to the information processing device 30 via the communication unit 10b (step S220). That is, the processor 10a specifies the interrupted print job based on the identification information, referring to the process management data 10c3, and transmits an instruction for interruption to the information processing device 30 to which the printing device 40 that is the execution agent of the print job is coupled, as the transmission target. The instruction for interruption includes the identification information of the interrupted print job. Meanwhile, when it is not determined in step S215 that an interruption is accepted, the processor 10a skips step S220.

In the information processing device 30, the processor 30a determines whether an interruption is accepted or not (step S115). That is, the processor 30a determines whether an instruction to interrupt the print job is received via the communication unit 30b or not. When it is determined in step S115 that an interruption is accepted, the processor 30a, by the function of the printing unit 30a1, determines whether the print job is interruptible via the communication unit 30b or not (step S120). That is, based on the identification information of the print job included in the instruction for interruption, the processor 30a determines that the print job is interruptible, when the print job indicated by the identification information is unexecuted. Also, even in the case where the printing is started, when the degree of progress of the print processing is equal to or lower than a prescribed degree (for example 50% or less, or the like), the processor 30a determines that the print job is interruptible.

When it is not determined in step S120 that the print job is interruptible, the processor 30a, by the function of the transmission unit 30a2, notifies the print job management device 10 that the print job is uninterruptible, via the communication unit 30b (step S125). The processor 10a of the print job management device 10, by the function of the holding unit 10a2, determines in step S225 whether the print job is interruptible or not. That is, when it is notified by the information processing device 30 in step S125 that the print job is uninterruptible, the processor 10a does not determine that the print job is interruptible, based on this notification.

In this case, the processor 10a, by the function of the holding unit 10a2, notifies the manager terminal 20 that the interruption has failed, via the communication unit 10b (step S230). The processor 20a of the manager terminal 20, by the function of the display unit 20a2, determines in step S315 whether the interruption has failed or not. That is, when it is notified by the print job management device 10 in step S230 that the print job is uninterruptible, the processor 20a determines that the interruption has failed, based on this notification.

When it is determined in step S315 that the interruption has failed, the processor 20a, by the function of the display unit 20a2, controls the display 20d to display a notification that the interruption of the print job which the instruction for interruption is given has failed, on the management screen (step S320). Subsequently, the processor 20a repeats the processing from step S300 onward. Meanwhile, when it is not determined in step S315 that the interruption has failed, the processor 20a skips step S320 and repeats the processing from step S300 onward.

The description now refers back to step S120. When it is determined in step S120 that the print job is interruptible, the processor 30a interrupts the print job and transmits the identification information of the interrupted print job to the print job management device 10 by the function of the transmission unit 30a2 (step S130). Meanwhile, the processor 10a of the print job management device 10 determines whether the identification information of the interrupted print job is received or not (step S235).

When it is determined in step S235 that the identification information of the interrupted print job is received, the processor 10a holds the color information and updates the process management data 10c3, by the functions of the holding unit 10a2 and the management unit 10a1 (step S240). That is, the processor 10a specifies the print condition of this print job, based on the received identification information of the print job and with reference to the case data 10c2. The processor 10a then causes the storage medium 10c to hold the color information included in the print condition. At this point, at least the color information, of the information included in the print condition, may be held in the storage medium 10c. However, other information included in the print condition may be held as well.

In any case, as the color information included in the print condition of the interrupted print job is held, the color expected to be printed in the interrupted print job can be specified. As such a color can be specified, the printing device that can print this color can be specified and the printing device to resume the print job can be selected. Thus, the holding of the color information may be implemented in such a way that the color information continues to be stored in the storage medium 10c until the printing device to resume the print job is specified.

The color information can include profile information, which is information representing a color gamut, spot color information indicating that the object to be printed is in a spot color, sample color information indicating that the object to be printed is in a sample color, and information representing a coloring material and a print medium, as described above.

In step S240, the color information included in the print condition of the interrupted print job is held. Therefore, the information representing a coloring material and a print medium, included in the color information, is information representing the coloring material and the print medium used in the printing device that is the execution agent of the interrupted print job. In this embodiment, since a color profile corresponds to a coloring material and a print medium, it can be said that the information representing a coloring material and a print medium is profile information representing a color profile. It can also be said that the profile information represents the color profile used in the printing device that is the execution agent of the interrupted print job. When the color information represents spot color information, the spot color information indicates that the color of a specified object to be printed in the interrupted print job is designated to be a spot color. Also, when the color information includes sample color information, the sample color information indicates that the color of a specified object to be printed in the interrupted print job is designated to be a sample color.

In step S240, the update of the process management data 10c3 is performed in addition to the holding of the color information. Specifically, processor 10a, by the function of the management unit 10a1, deletes the information of the interrupted print job from the process management data 10c3. Consequently, the interrupted print job is no longer in the execution waiting state. In this embodiment, on the assumption that the print job is to be resumed, the processor 10a does not delete the interrupted print job from the case data 10c2 but holds the interrupted print job therein. However, in order to select the printing device 40 that can reproduce the color, it suffices that at least the color information is held. Therefore, the other print conditions or the like may be deleted. In this case, the print condition is re-set when resuming the print job. When step S240 is executed, the process management data 10c3 is updated and information indicating that the print job is interrupted is displayed on the management screen in step S300.

When step S125 or S130 is executed, or when it is not determined in step S115 that an interruption is accepted, the processor 30a determines whether the print job is complete or not (step S135). That is, when the print job that starts to be executed in step S105 is complete, information representing the completion of the print job is transmitted from the printing device 40 to the information processing device 30. When this information is received, the processor 30a determines that the print job is complete.

When it is determined in step S135 that the print job is complete, the processor 30a notifies of the completion of the print job (step S140) and repeats the processing from step S100 onward. When it is not determined in step S135 that the print job is complete, the processor 30a skips step S140 and repeats the processing from step S100 onward.

When the completion of the print job is notified of in step S140, the identification information of the completed print job is transmitted to the print job management device 10. In this case, the processor 10a of the print job management device 10 in step S210 updates the process management data 10c3 in such a way as to delete the print job represented by the identification information, from the process management data 10c3.

### (2-1) Resumption of Print Job

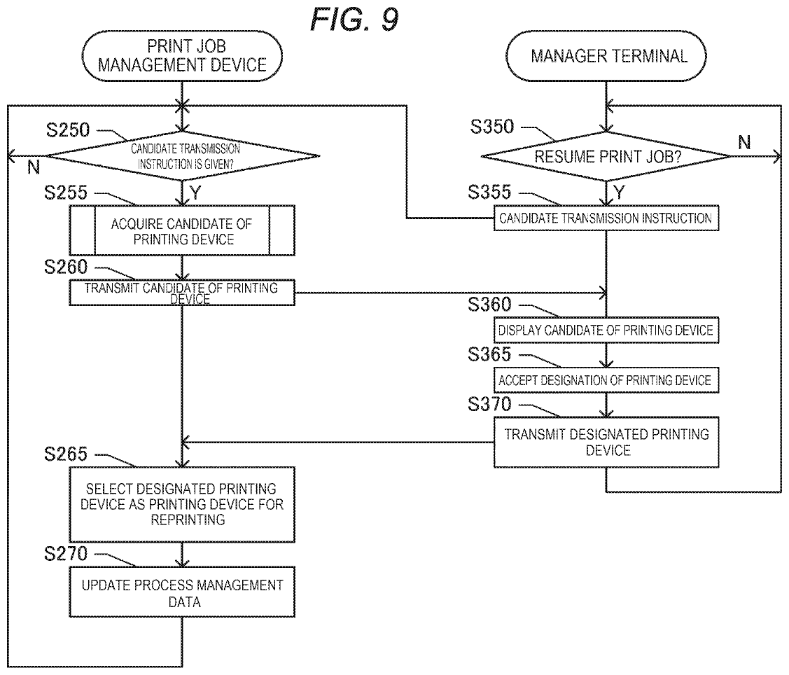

The processing for resuming the print job in the state where the color information is held as described above will now be described. FIG. 9 is a flowchart showing this processing. The manager can operate the manager terminal 20 to give an instruction to resume the print job. The instruction for resumption may be given in various forms. For example, the instruction for resumption is given in such a form as the manager selecting the interrupted print job on the management screen displayed in the foregoing step S300, where the interrupted print job is displayed in a selectable manner.

The processor 20a of the manager terminal 20, by the function of the instruction unit 20a1, determines whether an instruction to resume the print job is given by the manager or not (step S350). When it is not determined in step S350 that an instruction to resume the print job is given, the processor 20a repeats the processing from step S350 onward every predetermined period.

When it is determined in step S350 that an instruction to resume the print job is given, the processor 20a, by the function of the instruction unit 20a1, outputs a candidate transmission instruction (step S355). That is, the processor 20a instructs the print job management device 10 to transmit a candidate of the printing device, via the communication unit 20b.

The processor 10a of the print job management device 10 determines whether a candidate transmission instruction is given or not (step S250). When an instruction is given in step S355, the processor 10a determines that a candidate transmission instruction is given. When it is not determined in step S250 that a candidate transmission instruction is given, the processor 10a repeats the processing from step S250 onward.

Meanwhile, when it is determined in step S250 that a candidate transmission instruction is given, the processor 10a, by the function of the selection unit 10a3, acquires a candidate of the printing device 40 (step S255). The processing of this step S255 will be described later. When step S255 is executed, the printing device 40 that can print at least a part of the colors expected in the interrupted print job is acquired as a candidate, based on the color information of the interrupted print job.

Thus, the processor 10a, by the function of the selection unit 10a3, transmits the candidate of the printing device 40 (step S260). That is, the processor 10a transmits information representing the identification information of the printing device 40 that has become a candidate to the manager terminal 20 via the communication unit 10b. The processor 20a of the manager terminal 20 receives the identification information via the communication unit 20b and controls the display 20d to display the candidate of the printing device 40 (step S360). As described above, the processor 10a, by the function of the selection unit 10a3, selects a candidate of the printing device 40 and causes the display 20d, which is an example of the display device, to display the selected printing device 40. This configuration enables the manager to recognize the printing device 40 that can print at least a part of the colors expected in the interrupted print job.

In this embodiment, when the printing device 40 that is a candidate is displayed, information representing a reason for the candidacy is displayed as well.

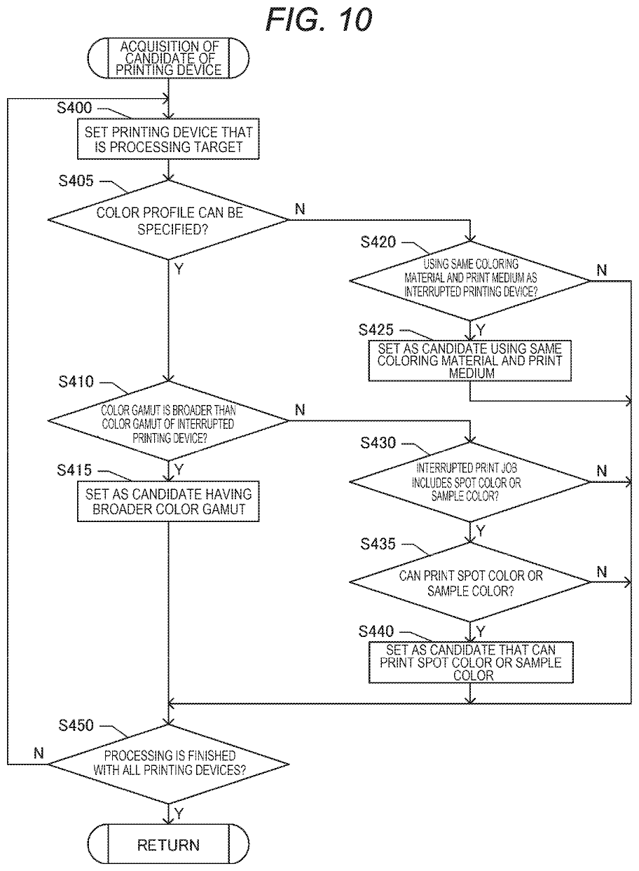

Specifically, by the processing shown in FIG. 10, described later, one of the following reasons corresponds to the printing device that has become a candidate:

Having a broader color gamut than the printing device 40 that is the execution agent of the interrupted print job; Being able to print the spot color or the sample color included in the interrupted print job; and Using the same coloring material and print medium as the printing device 40 that is the execution agent of the interrupted print job.

When displaying the candidate of the printing device 40, the processor 10a displays information representing this reason along with the identification information of the printing device 40. This configuration enables the manager to recognize the reason for the printing device 40 to become a candidate.

Next, the processor 20a, by the function of the instruction unit 20a1, accepts the designation of the printing device 40 (step S365). That is, the processor 20a specifies the printing device 40 inputted by the manager operating the input unit 20e and specifies the identification information of this printing device. Then, the processor 20a, by the function of the instruction unit 20a1, transmits the designated printing device (step S370). That is, the processor 20a controls the communication unit 20b to transmit the identification information of the printing device 40 designated in step S365 to the print job management device 10.

The processor 10a of the print job management device 10, by the function of the selection unit 10a3, selects the designated printing device 40 as the printing device 40 for reprinting (step S265). Then, the processor 10a, by the function of the management unit 10a1, defines the printing device 40 selected in step S265 as the execution agent and updates the process management data 10c3 in such a way that the interrupted print job waits for execution (step S270). Various orders of execution may be employed. The interrupted print job may come last in the order of the existing print jobs or may come next to the print job that is now being executed. Also, the order of execution may be selected by the manager or the like or may be decided based on the date of delivery or the like. According to the foregoing configuration, an interrupted print job can be resumed by the printing device 40 that can print at least a part of the colors expected in the interrupted print job. Therefore, at least this part of the colors can be outputted as expected in the interrupted print job.

### (2-2) Acquisition of Candidate of Printing Device

The candidate acquisition processing for the printing device 40 in step S255 will now be described. FIG. 10 is a flowchart showing the candidate acquisition processing for the printing device 40. As the candidate acquisition processing is started, the processor 10a, by the function of the selection unit 10a3, sets the printing device 40 that is a processing target (step S400). That is, in this embodiment, printing can be executed by a plurality of printing devices 40 managed by the print job management device 10. In step S400, the processor 10a selects one printing device 40 that is not used as a processing target in the loop of steps S400 to S450, from among a plurality of printing devices 40, and defines the selected printing device 40 as a processing target. Subsequently, the processor 10a executes the processing from step S405 onward with respect to the printing device 40 of the processing target.

Next, the processor 10a, by the function of the selection unit 10a3, determines whether a color profile can be specified or not (step S405). A color profile is defined corresponding to a combination of a coloring material and a print medium. In cases such as where profile information corresponding to a combination of a coloring material and a print medium is not defined, a color profile cannot be specified. In step S405, the processor 10a refers to the color information held based on the print condition of the interrupted print job, and when it is not specified that any of the profile information 10c4 stored in the storage medium 10c is scheduled to be used, based on the color information, the processor 10a determines that a color profile cannot be specified.

When it is determined in step S405 that a color profile can be specified, the processor 10a, by the function of the selection unit 10a3, determines whether the color gamut of the printing device 40 of the processing target is broader than the color gamut of the interrupted printing device or not (step S410). That is, the processor 10a specifies the color profile of the printing device 40 that is the execution agent of the interrupted print job, referring to the color information held based on the print condition of the interrupted print job. The processor 10a also specifies the color profile of the printing device 40 of the proceeding target, based on the print condition allocated to the printing device 40 of the processing target or the print condition that can be set in the printing device 40 of the processing target.

The processor 10a also determines a color gamut based on the color profile of each of the printing device 40 of the processing target and the printing device 40 that is the execution agent of the interrupted print job, and compares the color gamuts. When the color gamut of the printing device 40 of the processing target includes the color gamut of the printing device 40 that is the execution agent of the interrupted print job, the processor 10a determines that the color gamut of the printing device 40 of the processing target is broader than the color gamut of the printing device 40 that is the execution agent of the interrupted print job. The comparison of the color gamuts can be implemented in various forms. For example, a plurality of cross sections perpendicular to the L-axis in the CIELAB space are assumed and the boundaries of the color gamuts are specified on these cross sections. Thus, the inclusion relationship of the color gamuts on these cross sections can be determined. This determination is performed with respect to each of the plurality of cross sections. Thus, whether one color gamut includes the other color gamut or not can be determined.

When it is determined in step S410 that the color gamut of the printing device 40 of the processing target is broader than the color gamut of the interrupted printing device, the printing device 40 of the processing target can be used to output all the colors that can be expressed by the printing device 40 that is the execution agent of the interrupted print job. Thus, in this case, the processor 10a, by the function of the selection unit 10a3, sets the printing device 40 of the processing target as a candidate having a broader color gamut than the printing device 40 that is the execution agent of the interrupted print job (step S415). That is, the processor 10a establishes a correspondence between the identification information of the printing device 40 of the processing target, and information representing that the printing device 40 of the processing target is a candidate and information representing that the printing device 40 of the processing target has a broader color gamut than the printing device 40 that is the execution agent of the interrupted print job. According to the foregoing configuration, the printing device 40 that can output all the colors expected in the interrupted print job can be defined as a candidate of the printing device 40 to resume the print job.

Meanwhile, when it is not determined in step S410 that the color gamut of the printing device 40 of the processing target is broader than the color gamut of the interrupted printing device, the processor 10a, by the function of the selection unit 10a3, determines whether the interrupted print job includes a spot color or a sample color, or not (step S430). That is, the processor 10a refers to the color information held based on the print condition of the interrupted print job, and when the color information includes at least one of spot color information and sample color information, the processor 10a determines that the interrupted print job includes a spot color or a sample color.

When it is determined in step S430 that the interrupted print job includes a spot color or a sample color, the processor 10a, by the function of the selection unit 10a3, determines whether the printing device 40 of the processing target can print the spot color or the sample color or not (step S435). That is, the processor 10a specifies the color profile of the printing device 40 of the processing target, based on the print condition allocated to the printing device 40 of the processing target or the print condition that can be set in the printing device 40 of the processing target. When the color gamut represented by the color profile includes the spot color or the sample color, the processor 10a determines that the printing device 40 of the processing target can print the spot color or the sample color. To determine whether the color gamut includes the spot color or the sample color, for example, a configuration to make the determination based on coordinate values in the CIELAB space, or the like, can be employed.

When it is determined in step S435 that the printing device 40 of the processing target can print the spot color or the sample color, the processor 10a, by the function of the selection unit 10a3, sets the printing device 40 of the processing target as a candidate that can print the spot color or the sample color (step S440). That is, the processor 10a establishes a correspondence between the identification information of the printing device 40 of the processing target, and information representing that the printing device 40 of the processing target is a candidate and information representing that the printing device 40 of the processing target can print the spot color or the sample color included in the interrupted print job. According to the foregoing configuration, the printing device 40 that can output the spot color or the sample color expected in the interrupted print job can be defined as a candidate of the printing device 40 to resume the print job.

When it is not determined in step S430 that the interrupted print job includes a spot color or a sample color, or when it is not determined in step S435 that the printing device 40 of the processing target can print the spot color or the sample color, the processor 10a skips step S440. In this case, the printing device 40 of the processing target is not defined as a candidate.

When it is not determined in step S405 that a color profile can be specified, the processor 10a, by the function of the selection unit 10a3, determines whether the printing device 40 of the processing target uses the same coloring material and print medium as the interrupted printing device or not (step S420). That is, the processor 10a specifies the type of the coloring material and the type of the print medium, referring to the color information held based on the print condition of the interrupted print job. The types of the coloring material and the print medium are the types of the coloring material and the print medium set in the printing device 40 that is the execution agent of the interrupted print job.

The processor 10a also determines whether a coloring material and a print medium of the same types as these coloring material and print medium are set in the printing device 40 of the processing target or not. A configuration where the coloring material and the print medium set in the printing device 40 of the processing target are saved in the information processing device 30 or the printing device 40 and are transmitted to the print job management device 10 at an arbitrary timing, can be employed.

When the coloring material and the print medium set in the printing device 40 of the processing target are the same, the processor 10a determines that the printing device 40 of the processing target uses the same coloring material and print medium as the interrupted printing device. When it is determined in step S420 that the printing device 40 of the processing target uses the same coloring material and print medium as the interrupted printing device, the processor 10a, by the function of the selection unit 10a3, sets the printing device 40 of the processing target as a candidate using the same coloring material and print medium (step S425). That is, the processor 10a establishes a correspondence between the identification information of the printing device 40 of the processing target, and information representing that the printing device 40 of the processing target is a candidate and information representing that the printing device 40 of the processing target uses the same coloring material and print medium as the printing device 40 that is the execution agent of the interrupted print job.

According to the foregoing configuration, the printing device 40 that is highly likely to be able to output a color equivalent to the color expected in the interrupted print job can be defined as a candidate of the printing device 40 to resume the print job. When it is not determined in step S420 that the printing device 40 of the processing target uses the same coloring material and print medium as the interrupted printing device, the processor 10a skips step S425. In this case, the printing device 40 of the processing target is not defined as a candidate.

When step S415, S425 or S440 is executed, or when step S425 or S440 is skipped, the processor 10a determines whether the processing is finished with all the printing devices 40 or not (step S450). That is, the processor 10a determines whether steps S400 to S450 have been executed with all of the plurality of printing devices 40 employed as a processing target, or not. When it is not determined in step S450 that the processing is finished with all the printing devices 40, the processor 10a repeats the processing from step S400 onward.

### (3) Other Embodiments

The foregoing embodiment is an example to implement the present disclosure. Various other embodiments can be employed. For example, while the print job management device 10 and the manager terminal 20 are formed of different devices from each other in the foregoing embodiment, the print job management device 10 and the manager terminal 20 may be formed of the same device or may be distributed to three or more devices. Also, the information processing device 30 and the printing device 40 may be unified together. The orders of execution of the processing shown in FIGS. 8 to 10 are not limited to the orders shown in these drawings. For example, steps S135 and S140 shown in FIG. 8 may be executed before step S100. The order of interchangeable processing other than this part may be changed.

The processing shown in FIGS. 8 to 10 is an example. At least partly different processing may be employed. For example, steps S420 and S425 may be inserted between steps S410 and S430 or may be inserted between step S440 and S450. In this configuration, step S450 may be executed when it is not determined in step S405 that a color profile can be specified. Also, a configuration where step S405 is omitted may be employed. The display device displaying a candidate of the printing device 40 is the display 20d of the manager terminal 20. However, the display device may be provided in or coupled to another device. For example, a display device or the like provided in or coupled to the printing device 40 or the information processing device 30 may be employed.

The management unit may be able to cause the printing device to execute a print job. To manage the execution of a print job in the printing device, various methods other than the foregoing method may be employed. For example, the order of execution of a print job may be decided according to the degree of priority. Also, the order of execution of a print job may be changed at an arbitrary timing by the manager or the like. Also, the order of execution of a print job may be adjusted in response to the progress or the like of other processes than printing, for example, calibration before printing and a process after printing. When the registration of a print job or printing based on a print job is complete, the case data 10c2 or the like representing the print condition or the like of the print job may be deleted from the print job management device 10.

The holding unit may be able to cause the storage medium to hold color information relating to an interrupted print job. Of course, a configuration where the holding unit causes the storage medium to hold information other than the color information, for example, the print condition of the print job or data for process management, as in the foregoing embodiment, may be employed. The color information may be information for being able to specify whether a candidate of the printing device can reproduce at least a part of the colors of the interrupted print job or not. Therefore, a part of the profile information, the information representing a coloring material and a print medium, the spot color information, and the sample color information in the foregoing embodiment may be the color information. Also, the color information may include other information. The other information may be, for example, information representing the color of an image included in the print target of the print job, in a device-independent color space. With this information, whether another printing device can reproduce the color of the print target or not can be determined.

Since the holding unit may hold the color information in such a way as to be able to reproduce at least a part of the colors of the interrupted print job, information other than the color information, for example, the print condition, may be deleted when the aim is the reproduction of the color. In this case, the print condition may be re-set at the time of resumption, or the print job may be resumed with another condition, for example, the default condition or the like. Even in this configuration, at least a part of the colors of the interrupted print job is reproduced.

The selection unit may be able to select, as a candidate, a printing device that can print a color used in the interrupted print job, based on the color information. That is, the selection unit may be able to select, as a candidate, a printing device that can reproduce at least a part of the colors of the interrupted print job. The color that can be reproduced may be a part or all of the colors.

The printing device that can print a color used in the interrupted print job may be able to execute the printing using at least a part of the colors represented by the color information. When specifying the printing device that can resume the interrupted print job, it is not required that all the items of the print condition of the interrupted print job are perfectly satisfied. For example, it may be regarded that the printing can be executed using the print condition of the interrupted print job when the condition is met with respect to a prescribed item, of the items of the print condition. It may also be regarded that the printing can be executed using the print condition of the interrupted print job when the printing can be executed with a condition similar to the print condition with respect to a prescribed item. Whether the print condition is similar or not may be specified, for example, based on whether the overlap rate of the color gamuts is equal to or higher than a threshold or not, whether the color of a specified object can be reproduced or not, or the like. Also, a candidate of the printing device may be specified based on the color information, without considering other print conditions than the color information at all.

The agent transmitting the identification information of the interrupted print job may be a device other than the information processing device and may be, for example, the manager terminal. Also, a configuration where the color information is transmitted along with the identification information to the print job management device may be employed.

The print condition may be a condition referred to when an image or a file that is a print target is printed. The print condition may be a set value that can change in printing. A set value may be selectable for a plurality of items. The items may be, for example, an item relating to computational processing, an item relating to hardware, and an item relating to consumable components. However, these items may be not clearly distinguished from each other.

The item relating to computational processing may be, for example, a set value for designating a color profile, a set value for designating a color of an object in an image, a set value indicating the value of a gamma curve referred to in image processing, or the like. The item relating to hardware may be, for example, a set value indicating whether to perform stapling or not, or the like. The item relating to consumable components may be, for example, a set value for designating a coloring material, a print medium, or the like.

In the foregoing embodiment, the manager gives an instruction to interrupt printing via the manager terminal, and an instruction to interrupt printing is given from the print job management device to the printing device that is now executing a print job. However, the instruction for interruption may be given from another device. For example, the instruction to interrupt the print job may be given to the printing device or the information processing device.

The selection unit may be configured to select, as a candidate, a printing device having a color gamut equivalent to or broader than the color gamut of the printing device previously executing the interrupted print job. Whether the color gamut of the printing device to be a candidate is equivalent to the color gamut of the printing device that is the execution agent of the interrupted print job or not may be specified based on whether the color gamuts are the same or not, or may be specified based on whether the overlap ratio of the color gamuts is equal to or higher than a threshold (for example 95%) or not. In any case, the color provided by the printing device to be a candidate may be similar to such a degree that this color cannot be distinguished from the color provided by the printing device previously executing the interrupted print job because the color gamut of the printing device to be a candidate is equivalent to or broader than the color gamut of the printing device that is the execution agent of the interrupted print job.

Whether the color gamut is equivalent or not may be specified based on the image of the print target. That is, the color used in the image that is the print target in the interrupted print job can be specified based on the print data. Therefore, if the color used in this image is included in the color gamut of the printing device to be a candidate, the color gamut of this printing device can be regarded as equivalent to the color gamut of the printing device that is the execution agent of the interrupted print job.

The spot color may be a particular color designated in the printed object. The sample color may be a color designated by a color sample. Various configurations can be employed for these colors. That is, the spot color and the sample color may be designated in various forms other than being designated in a device-independent color space as in the foregoing embodiment. For example, identification information such as DIC 198 or PANTONE 125c, DIC and PANTONE being trademarks registered, may be employed. In this case, the printing device or the information processing device decides the amount of the coloring material based on the identification information in such a way that the coloring material becomes the spot color or the sample color when recorded on the print medium set in the printing device. The color information may include one of the spot color and the sample color or may include both or may include neither of these colors.

The comparison between the color gamut of the printing device that is the execution agent of the interrupted print job and the color gamut of the printing device to be a candidate, based on the color profile, is not limited to the configuration where the color gamuts are compared in a device-independent color space as in the foregoing embodiment. For example, the relationship between the two color gamuts may be defined in advance in relation to the combination of the identification information of the color profiles. The relationship between the two color gamuts may be, for example, a relationship in which one color gamut includes the other, an overlap relationship in which the ratio at which one color gamut is included in the other is 95%, or the like. If such a relationship is defined in advance, the color gamuts can be compared with each other, based on the identification information of the color profiles since the identification information is held in the print job management device.

In the foregoing embodiment, when the coloring material and the print medium set in the printing device 40 of the processing target are not the same as the coloring material and the print medium in the interrupted printing device 40 in step S420, the printing device 40 of the processing target is not employed as a candidate. However, when there is no printing device using the same coloring material and print medium as the coloring material and the print medium used in the printing device that is the execution agent of the interrupted print job, a printing device that can use the same coloring material and print medium by replacement may be employed as a candidate.

That is, in a configuration where the coloring material and the print medium that can be used in the printing device 40 are defined in advance, the processor 10a can specify the printing device 40 that can use the coloring material and the print medium of the same type as in the interrupted printing device 40. In such a case, the processor 10a may select this printing device 40 as a candidate and may provide the manager with information representing that the coloring material and the print medium may be replaced. According this configuration, the range of candidates of the printing device 40 that are highly likely to be able to reproduce the color of the interrupted print job can be increased.

Also, the printing device 40 to be a candidate may be automatically selected by the processor 10a. When a plurality of printing devices 40 to be a candidate exist, the processor 10a can automatically select a printing device 40 if a rule for selecting a printing device 40 from among these printing devices 40 is defined. For example, a configuration where a priority order is set in such a way as to select a candidate in order of a candidate having a broader color gamut, a candidate that can print the spot color or the sample color, and a candidate using the same coloring material and print medium, or the like, can be employed.

Also, a configuration where, when a plurality of printing devices 40 to be a candidate exist, the processor 10a selects a plurality of printing devices 40, distributes the interrupted print job to the plurality of selected printing devices 40, and thus causes these printing devices 40 to print, may be employed. That is, the processor 10a divides the interrupted print job into a plurality of print jobs, allocates the divided print jobs to the plurality of candidate printing devices 40, and thus causes the interrupted print job to be a print job waiting for execution. This configuration enables early completion of the printing of the interrupted print job. To distribute the print job to the plurality of printing devices 40, a configuration where the print job is distributed only to the printing devices 40 selected as candidates for the same reason, thus causing these printing devices 40 to print, may be employed. For example, a configuration where, when there are two candidates having a broader color gamut and two candidates that can print the spot color or the sample color, the print job is distributed to the two printing devices 40 that are the candidates having a broader color gamut whereas the print job is not distributed to the two printing devices 40 that are the candidates that can print the spot color or the sample color, or the like, may be employed.

The present disclosure can also be applied as a program executed by a computer and as a method. The system, the program, and the method as described above may be implemented as a single device or may be implemented using components provided in a plurality of devices and include various aspects. Also, suitable changes can be made such as being partly software and partly hardware. Moreover, the present disclosure can be implemented as a storage medium storing a program controlling a system. Of course, the storage medium storing the program may be a magnetic storage medium or a semiconductor memory. Any storage medium to be developed in the future may be similarly applied.

The above embodiments do not limit the present disclosure. The embodiments include a plurality of technical ideas having different effects. Therefore, one problem or effect that can be understood from the embodiments may not be the problem or the effect of all the technical ideas included in the embodiments.

What is claimed is:

1. A print job management device comprising:
a management unit causing a printing device to execute a print job;
a holding unit causing a storage medium to hold color information associated with a color gamut of a printing device that is an execution agent of the print job that is interrupted, when the print job is interrupted; and
a selection unit selecting, as a candidate, a printing device that can print a color used in the print job that is interrupted, based on the color information.

2. The print job management device according to claim 1, wherein
in the storage medium, a print condition including the color information and corresponding to each of the print jobs is held,
the management unit causes the printing device to execute the print job, based on the print condition, and
the holding unit acquires identification information of the print job that is interrupted, from a device controlling the printing device that is the execution agent of the print job that is interrupted, and causes the storage medium to hold the color information of the print job represented by the identification information.

3. The print job management device according to claim 1, wherein
the color information includes information representing a color gamut of the printing device that is the execution agent of the print job that is interrupted, and
the selection unit selects, as the candidate, a printing device having a color gamut equivalent to or broader than the color gamut of the printing device that is the execution agent of the print job that is interrupted.

4. The print job management device according to claim 1, wherein
the color information includes information representing a color gamut of the printing device that is the execution agent of the print job that is interrupted, and
the selection unit selects, as the candidate, a printing device having a color gamut including the color gamut of the printing device that is the execution agent of the print job that is interrupted.

5. The print job management device according to claim 1, wherein
the color information includes at least one of spot color information representing that an object to be printed in the print job that is interrupted is in a spot color and sample color information representing that the object to be printed is in a sample color, and
the selection unit selects, as the candidate, a printing device having a color gamut including at least one of the spot color represented by the spot color information and the sample color represented by the sample color information.

6. The print job management device according to claim 1, wherein
the color information includes profile information representing a color profile used in the printing device that is the execution agent of the print job that is interrupted, and
the selection unit selects the candidate, based on the profile information.

7. The print job management device according to claim 6, wherein
the selection unit determines the color gamut of the printing device that is the execution agent of the print job that is interrupted, based on a coordinate value in a device-independent color space represented by the profile information created for each print medium, and selects the candidate, based on the determined color gamut.

8. The print job management device according to claim 1, wherein
the color information includes information representing a coloring material and a print medium used in the printing device that is the execution agent of the print job that is interrupted, and
the selection unit selects, as the candidate, a printing device using a coloring material and a print medium that are same as the coloring material and the print medium used in the printing device that is the execution agent of the print job that is interrupted.

9. The print job management device according to claim 8, wherein
when the printing device using a coloring material and a print medium that are the same as the coloring material and the print medium used in the printing device that is the execution agent of the print job that is interrupted does not exist, the selection unit selects, as the candidate, a printing device that can use the same coloring material and print medium by replacement.

10. The print job management device according to claim 1, wherein
the selection unit causes a display device to display the selected printing device.

11. The print job management device according to claim 1, wherein
when there is a plurality of selected printing devices, the selection unit distributes the print job that is interrupted to the plurality of selected printing devices and thus causes the plurality of selected printing devices to print.

12. A print job management method comprising:
a management step of causing a printing device to execute a print job;
a holding step of causing a storage medium to hold color information associated with a color gamut of a printing device that is an execution agent of the print job that is interrupted, when the print job is interrupted; and
a selection step of selecting, as a candidate, a printing device that can print a color used in the print job that is interrupted, based on the color information.

13. A non-transitory computer-readable storage medium storing a print job management program, the print job management program causing a computer to function as:
a management unit causing a printing device to execute a print job;
a holding unit causing a storage medium to hold color information associated with a color gamut of a printing device that is an execution agent of the print job that is interrupted, when the print job is interrupted; and
a selection unit selecting, as a candidate, a printing device that can print a color used in the print job that is interrupted, based on the color information.
